(19) United States
(12) Patent Application Publication
(10) Pub. No.: US 2011/0171553 A1
(43) Pub. Date: Jul. 14, 2011

(54) FUEL CELL AND METHOD OF PRODUCING THE SAME

(75) Inventors: Mario Zedda, Freiburg (DE); Michael Oszcipok, Weilheim (DE); Alexander Dyck, Pirmasens (DE); Ulf Groos, Freiburg (DE)

(73) Assignees: FRAUNHOFER-GESELLSCHAFT ZUR FORDERUNG DER ANGEWANDTEN FORSCHUNG E.V., Munchen (DE); FWB KUNSTSTOFFTECHNIK GMBH, Pirmasens (DE)

(21) Appl. No.: 12/867,809

(22) PCT Filed: Feb. 16, 2009
(86) PCT No.: PCT/EP2009/001067

§ 371 Date: Apr. 1, 2011

(30) Foreign Application Priority Data
Feb. 15, 2008 (DE) 10 2008 009 414.5

(51) Int. Cl. H01M 8/24; H01M 8/10; H01M 8/00

(52) U.S. Cl. 429/455; 429/482; 429/535

(57) ABSTRACT

The invention relates to a fuel cell having a membrane electrode assembly, anode-side and cathode-side electrodes, current collector structures and distribution structures for fuel and oxidant. Furthermore, the invention relates to a method for the production of such fuel cells and also to a stack comprising a plurality of such fuel cells.

The invention relates to a fuel cell having a membrane electrode assembly, anode-side and cathode-side electrodes, current collector structures and distribution structures for fuel and oxidant. Furthermore, the invention relates to a method for the production of such fuel cells and also to a stack comprising a plurality of such fuel cells.

Fuel cell systems which have a membrane electrode assembly are known, which assembly is provided respectively on the cathode- and anode-side with current collector structures and have corresponding supply lines for fuel and oxidants.

Such planar, self-breathing fuel cells are frequently produced with the help of machining processes and mounted by conventional joining technologies. These are in particular gluing techniques or mechanical connection such as screwing or clamping. However, these production processes are generally complex, expensive and present problems with respect to precision.

A further problem with such fuel cells is transporting away product water at the self-breathing, exposed electrodes. Passive product water transport is effected merely by evaporation of the condensed water on the electrode surface. This is thereby reduced by water incorporation, which leads to less performance of the fuel cell because of the reduced active electrode surface.

Problems can also occur with respect to transporting in the fuel, e.g. hydrogen, methanol, ethanol or chemical hydrides. It is attempted here to create a solution by means of active elements, e.g. pumps or valves. However, such solutions are susceptible to faults and, because of the intrinsic consumption of the active peripheral units, reduce the electrical efficiency of the fuel cell.

Starting herefrom, it was the object of the present invention to provide fuel cells which can be produced with high precision and low production costs. At the same time, fuel cells with higher efficiency are intended to be made possible.

This object is achieved by the generic fuel cell having the characterising features of claim 1, by the stack having the features of claim 17 and the method for the production of fuel cells having the features of claim 18. The further dependent claims reveal advantageous developments.

According to the invention, a fuel cell is provided which has the following components:
a) at least one membrane electrode assembly, comprising at least one anode-side and one cathode-side electrode and also at least one membrane disposed between the electrodes,
b) current collector structures disposed on the anode-side and cathode-side and also
c) distribution structures for fuel and oxidant disposed on the anode-side and cathode-side.

It is a particular feature of the present invention that the mentioned components a) to c) are integrated in a monolithically constructed carrier structure.

There should be understood by monolithic carrier structure within the scope of the present invention, a carrier structure which forms an inseparable assembly in the end state, i.e. consists of one piece. However, there should also be understood by this, carrier structure halves which are connected to each other integrally in the production process without using additional sealing means, e.g. adhesives or mechanical connections.

The carrier structure preferably consists of a polymer and/or ceramic material or essentially comprises these materials.

As polymer materials, in particular those from the group of high performance polymers are preferred. There should be understood by high performance polymers within the scope of the present application, polymers which are distinguished relative to conventional polymers by particular properties. There are included herein inter alia high permanent heat resistance, high mechanical strength and high purity.

Polymers of this type, given by way of example, are polyesters, partially fluorinated polymers, polyacrylates, polyetherimides, polyethersulphones, polyetherketones, polysulphones, liquid-crystalline polymers, polyphenylsulphides, polyacrylimides, polyamide imides, polyacetals and blends thereof.

The ceramic material is preferably selected from the group of ultrahigh-strength oxide ceramics. There are included herein in particular ceramics based on zirconium oxide, aluminium oxide, silicon oxide and mixed oxides thereof.

It is preferred that a casting produced in an automated fashion is used as carrier structure. Process techniques suitable for this purpose are injection moulding, embossing or stamp shaping. It is made possible in this way to integrate planar fuel cells jointly with current collector structures and distribution structures in the carrier structure with the help of a casting process. As a result, it is made possible that the fuel cells are directly sealed externally without a further processing step being required.

A further preferred alternative provides that the carrier structure is formed from at least two parts, these parts being connected to each other integrally subsequently by ultrasonic welding and/or sintering. With respect to the practical conversion, this can be achieved for example such that the carrier structure is manufactured as upper and lower plate made of a polymer material or a ceramic material with the help of a casting process. These plates can then have webs or similar structures which are connected to each other in a subsequent step. There are possible here as connection techniques ultrasonic welding processes or sintering processes. In this variant also, the internal fuel cells can be encapsulated relative to the environment in a gas-impermeable and liquid-impermeable manner.

In order to enable high flexibility of the fuel cell, it is likewise preferred that connections for the supply of fuel and oxidant are integrated in the carrier structure. There are included herein in particular olives or plug-in connections for the connection of hoses or adaptors. In this way, the fuel cells can be directly sealed externally without a further processing step being required during production.

A further preferred variant provides that the carrier structure has a pre-stress which enables a homogeneous contact pressure on the layer construction of the electrodes and of the at least one membrane. The material of the carrier structure has a pre-stress during fixing of the electrodes so that a permanently pre-adjusted compression of the active components is present.

Fuel cells can have capillary structures on the anode- and cathode-side for transporting media, in particular educts and reaction products, such as e.g. water. Such capillary structures, such as e.g. pockets or similar structures, can be inserted in the casting mould and can be fixed during the casting process on the outside and/or inside of the component according to the invention. These capillary structures then assume for example the function of passive transporting away of reaction products Likewise, it is however also possible that the capillary structures are imaged in the casting material directly during the casting process so that injection or further materials can be dispensed with.

A further preferred variant provides that the fuel cell is coated on the cathode-side and/or anode-side surface hydrophilically and/or hydrophobically. The coating thereby consists preferably of a fibre material, particularly preferred in the form of flocking. These coatings can then also be used for transporting in the fuel and/or for transporting away the reaction products.

Likewise, the fuel cell can have, on the cathode-side and/or anode-side surface, a metallisation which can serve for example as current collector structure or wiring.

It is further preferred that the fuel cell has diffusion layers on the cathode-side and anode-side.

It is likewise possible that the fuel cell has at least one gas separating membrane for discharging gaseous media.

According to the invention, a stack which comprises at least two of the above-described fuel cells is likewise provided.

Furthermore, a method for the production of the above-described fuel cell is provided according to the invention, in the case of which, by means of automated casting, the membrane electrode assembly, the current collector structures and the distribution structures for fuel and oxidant are integrated in the carrier structure.

A further variant of the method according to the invention for the production of fuel cells provides that the carrier structure is constructed from at least two parts, the membrane electrode assembly, the current collector structures and the distribution structures for fuel and oxidant are incorporated in the carrier structure and subsequently an integral connection of the at least two parts of the carrier structure is effected.

The integral connection is thereby effected preferably by ultrasonic welding and/or sintering.

Furthermore, it is preferred that in addition capillary structures are integrated in the carrier structure for transporting media, in particular educts and reaction products, connections for the supply also within the fuel cell of fuel and oxidant.

The above-described fuel cell according to the invention and the method for production thereof confer the advantage that fuel cells with high precision and low production costs can be produced. The assembly with the help of the mentioned connection technologies, e.g. ultrasonic welding or sintering, is very rapid and demands in particular no additional materials Likewise, the described integration of capillary structures in the casting process can improve the water balance and discharge of product water passively. As a result, the efficiency of planar fuel cell systems is increased. Due to the described defined surface coating, the water balance can likewise be controlled as a function of temperature, free convection and defined recirculation.

The subject according to the invention is intended to be described in more detail with reference to the subsequent FIGURE without wishing to restrict said subject to the special embodiments shown here.

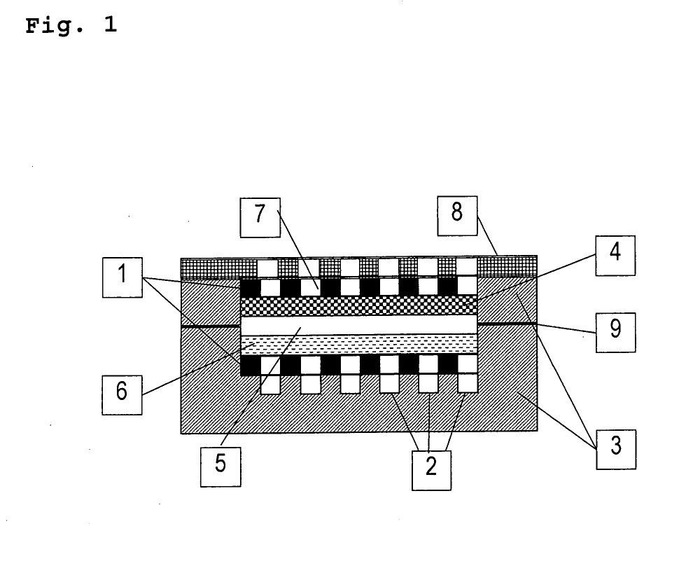

In FIG. 1, a fuel cell according to the invention is illustrated, which shows an upper housing half 3 and a lower housing half 3′, which form the carrier structure. A membrane electrode assembly comprising a membrane 5, a cathode 4 and an anode 6 is integrated in this carrier structure. Furthermore, current collector structures 1, 1′ are embedded in the carrier structure on the anode-side and cathode-side. On the anode-side, there are situated furthermore fuel distributor channels 2 which are disposed on the side of the current collector structure orientated away from the anode 6. On the cathode-side, additional oxidation channels 7, which can have for example a hydrophilic or also hydrophobic surface, are disposed. Furthermore, the cathode-side reveals hydrophilic and/or hydrophobic capillary structures 8. The connection of the housing halves 3, 3′ is represented by the joint seam 9 which can be for example an ultrasonic weld seam. The membrane has a sealed surface 10 relative to the carrier structure so that encapsulation is present relative to the environment.

1. A fuel cell having
a) at least one membrane electrode assembly, comprising at least one anode-side and one cathode-side electrode and also at least one membrane disposed between the electrodes,
b) current collector structures disposed on the anode-side and cathode-side and also
c) distributor structures for fuel and oxidant disposed on the anode-side and cathode-side,
wherein the components a) to c) are integrated in a monolithically constructed carrier structure.

2. The fuel cell according to claim 1,
wherein the carrier structure consists of or essentially comprises a polymer and/or ceramic material.

3. The fuel cell according to claim 2,
wherein the polymer material is selected from the group of high performance polymers.

4. The fuel cell according to claim 2,
wherein the ceramic material is selected from the group of ultrahigh-strength oxide ceramics.

5. The fuel cell according to claim 1,
wherein the carrier structure is in one piece.

6. The fuel cell according to claim 1,
wherein the carrier structure is a casting produced in an automated fashion.

7. The fuel cell according to claim 1,
wherein the carrier structure is formed from at least two parts which are connected to each other integrally by ultrasonic welding and/or sintering.

8. The fuel cell according to claim 1,
wherein the anode-side of the fuel cell is encapsulated relative to the environment in a gas- and liquid-impermeable manner.

9. The fuel cell according to claim 1,
wherein connections for the supply of fuel and oxidant are integrated in the carrier structure.

10. The fuel cell according to claim 1,
wherein the carrier structure has a pre-stress which enables a homogeneous contact pressure on the layer construction of the electrodes and of the at least one membrane.

11. The fuel cell according to claim 1,
wherein the fuel cell has capillary structures on the cathode- and/or anode-side for transporting media.

12. The fuel cell according to claim 1,
wherein the fuel cell is coated on the cathode-side and/or anode-side surface hydrophilically and/or hydrophobically.

13. The fuel cell according to claim 12,
wherein the coating consists of a fibre material.

14. The fuel cell according to claim 1,
wherein the fuel cell has, on the cathode-side and/or anode-side surface, a metallisation which serves as current collector structure and/or wiring.

15. The fuel cell according to claim 1,
wherein the fuel cell has diffusion layers on the cathode-side and anode-side.

16. The fuel cell according to claim 1,
wherein the fuel cell has at least one gas separating membrane for discharging gaseous media.

17. A stack comprising at least two fuel cells according claim 1.

18. A method for the production of a fuel cell according to claim 1, comprising integrating in the carrier structure the membrane electrode assembly, the current collector structures and the distribution structures for fuel and oxidant by automated casting.

19. A method for the production of a fuel cell according to claim 1, comprising constructing the carrier structure from at least two parts, incorporating the membrane electrode assembly, the current collector structures and the distribution structures for fuel and oxidant in the carrier structure and providing an integral connection of the at least two parts of the carrier structure.

20. The method according to claim 19,
wherein the integral connection is provided by ultrasonic welding and/or sintering.

21. The method according to claim 18,
further comprising integrating capillary structures in the carrier structure for transporting media and connections for the supply within the fuel cell of fuel and oxidant.
